(19) United States
(12) Patent Application Publication
(10) Pub. No.: US 2015/0356159 A1
(43) Pub. Date: Dec. 10, 2015

(54) ESTABLISHING CREDIBILITY OF ONLINE-CONTENT GENERATED FROM CROWD SOURCING

(71) Applicant: AGT International GmbH, Zurich (CH)

(72) Inventor: Eitan HADAR, Nesher (IL)

(21) Appl. No.: 14/730,248

(22) Filed: Jun. 4, 2015

Related U.S. Application Data
(60) Provisional application No. 62/007,968, filed on Jun. 5, 2014.

(51) Int. Cl. G06F 17/30; H04L 29/08; G06F 17/22

(52) U.S. Cl. CPC G06F 17/30572; G06F 17/2235; G06F 17/30882; H04L 67/02

(57) ABSTRACT

A content management system configured to corroborate on-line content derived from crowd sourcing by providing browsing capabilities of sources and contributors of content items incorporated into moderated online-content and display user feedback indicative of confidence levels of credibility of the online-content.

### BACKGROUND OF THE INVENTION

The present invention relates, generally, to content management systems in online content generation from crowd sourcing, and specifically, to establishing credibility of the content.

### BRIEF DESCRIPTION OF THE DRAWINGS

The subject matter regarded as the invention is particularly pointed out and distinctly claimed in the concluding portion of the specification. The features, primary components, method of operation, and advantages of the content management system may best be understood in reference to the following detailed description and accompanying drawings in which:

FIG. 1 is a block diagram of hardware employed in the content management system , according to an embodiment;

FIG. 2 is a block diagram of software modules and data units employed in the content management system , according to an embodiment;

FIGS. 3A and 3B are sample content pages depicting separate stories and respective sources and contributors of incorporated content items, according to an embodiment;

FIG. 4 depicts a panel of credibility metrics displaying credibility levels of content items incorporated into one of the stories depicted in the content page of FIG. 3, according to an embodiment;

FIG. 5 depicts a credibility metric in the form of a contributor page, according to an embodiment;

FIG. 6 depicts feedback metrics generated from user feedback for online-content, incorporated content items, and contributors, according to an embodiment; and

FIG. 7 is a flowchart of steps employed by the content management system to provide readers with a user-based, creditability level of the online-content and incorporated content items, according to an embodiment.

It should be noted that the figures are embodiments in no way limiting the scope of the invention.

### DETAILED DESCRIPTION OF EMBODIMENTS

It should be appreciated that for clarity of illustration elements appearing in the figures may not be drawn to scale.

Embodiments of the present invention relate to a content management system for corroborating open information to increase its reliability so that accurate and trusted sources are shared.

Specifically, the present invention is directed to establishing credibility of online-content from contributed content items by providing vetting capability of sources and contributors of the content items. Furthermore, the content management system provides editorial capabilities with workflow tracking of the activities in the creation of the article, according to an embodiment.

The following terms are used throughout the document:

The term “open information” refers to information having unrestricted access.

The term “crowd sourcing” refers to solicitation of an online community for content. Content voluntarily provided is also deemed to be crowd sourced.

The term “computer” refers to a processor and all associated hardware.

The term “online-content” refers to stories, articles, or other content published on a computer accessible through a network. It should be appreciated that these terms may be used interchangeably.

The term “online” refers to a state of being accessible through a computer network like internet or intranet, for example.

The term “vetting” refers to an investigative process directed at ascertaining additional information that can shed light on the reliability of the item being investigated.

The term “source” refers to the location of material one step prior to transfer to the content management system. “Original source” refers to the earliest identifiable location of the material after its creation. “Location” refers to either a geographical location or a network location, i.e. a uniform resource locator.

The term “contributor” refers to the creator of a content item.

The term “provider” refers to one who transfers content items from a source to the content management system. In some cases the contributor may also be the provider.

The term “reader” refers to user from the public who is not an editor.

The term “moderated” refers to content that is at least partially constructed from materials provided by others.

The term “cyber source” refers to an information source emanating from a computing environment as opposed to a human being.

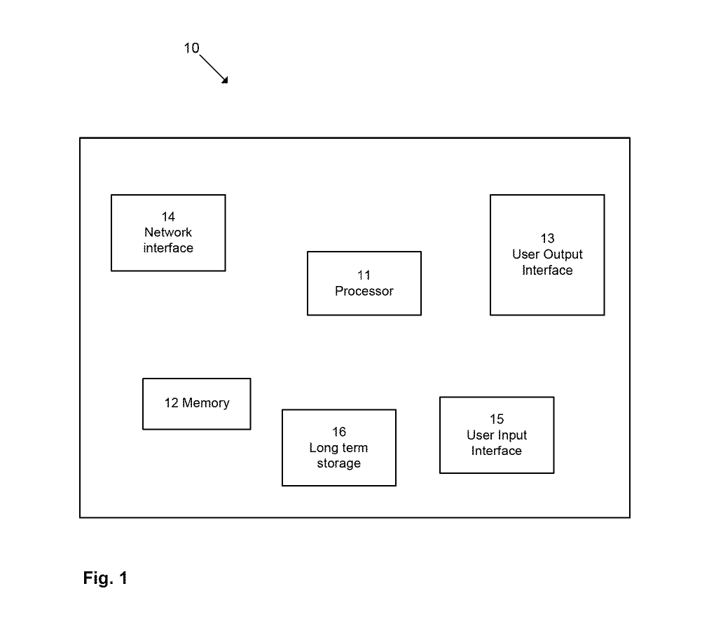

Turning now to the figures, FIG. 1 is a block diagram of hardware employed in embodiments of a content management system 10 including, inter alia, a processor 11, a network interface 14, a memory 12, long term storage 16, a user output interface 13, and user input interface 15.

Content management system 10 may be implemented as one or more stand alone computers or mobile devices. Processor 11 may be implemented as one or more processors. Network interface 14 may be implemented as an interface for either wired network or wireless networks.

Memory 12 may be or may include, for example, one or more memory units of Random Access Memory (RAM), read only memory (ROM), Dynamic RAM (DRAM), Synchronous DRAM (SD-RAM), double data rate (DDR) memory chip, Flash memory, volatile memory, a non-volatile memory, a cache memory, or other suitable memory units or storage units.

Long term storage 16 may be or may include, for example, as a hard disk, a Compact Disk (CD), a CD-Recordable (CD-R), a universal serial bus (USB) device or other suitable removable and/or fixed storage unit, and may include multiple or a combination of such units.

User output interface 13 may be implemented as a one or more display screens, touch screens, or printers, for example.

User input interface 15 may be implemented as, a keyboard, a keypad, a touch screen, a microphone, or a pointer device, for example.

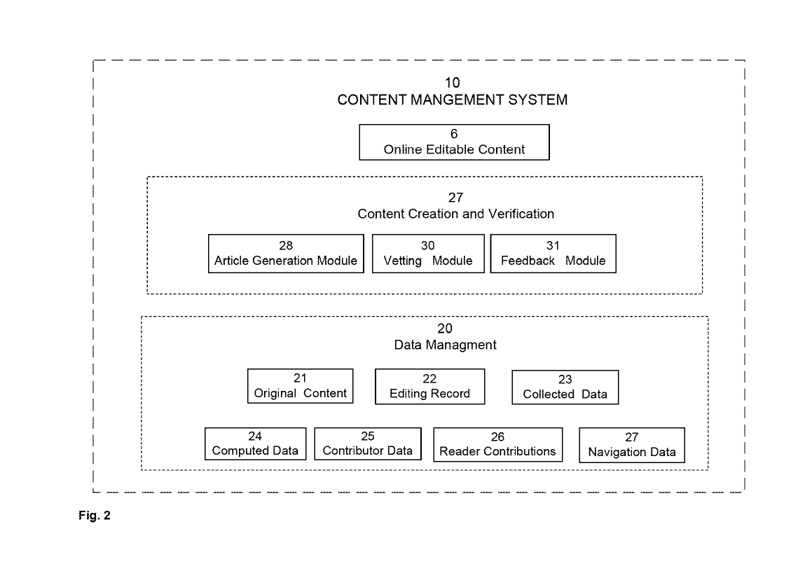

FIG. 2 is a block diagram of functional blocks including associated program modules and data units employed in an embodiment of content management system 10 for the generation of online-content 6. As shown, content creation and verification block 27 including various program modules linked to data management block 20 including various data units or bases, according to an embodiment.

Specifically, content creation and verification block 27 includes an article generation module 28, a vetting module 29, and feedback module 31, according to an embodiment.

Article generation module 28 is implemented as an online word-processor accessible to multiple editors and linked to system data units. Article generation module 28 includes workflow tracking and editor interaction functionality to enable tracking of each draft during various stages of construction, according to an embodiment.

When an editor collects information from content management system 10, the system automatically maps all the data items associated with the story. Furthermore, the system is configured to enable a user to mark data items and noted contributors with vetting indicators displaying information like, inter alia, name and profession in addition to details of the actual vetting activity, like the time and depth of the vetting, according to an embodiment. The depth of vetting refers to the depth of the background research; in regards to vetting of contributor, it could include academic degrees obtained, university attended and even fellow graduates, for example.

The vetting module 30 advantageously empowers editors with the power to develop trusted and credible content that can imbue users with a sense of trust in the credibility of the content.

Specifically, vetting module 30 is configured to monitor content item source attributes assigned to the content item when fed into system 10 or when vetted, according to an embodiment.

These attributes may be vetted by an editor to ascertain, inter alia, the source of a content item, the level of reliability of the source, and the contributor.

Furthermore, vetting metadata is gathered in regards to the nature of vetting query, the investigator, date and place of vetting, to facilitator editors to track prior vetting activities as noted above.

For example, prior to publishing, a chief editor can run a vetting query of content-items supporting a story previously vetted by editorial staff. Furthermore, a chief editor can navigate between sources to obtain a vetting history setting forth, inter alia, reasons or rational for the absence of vetting for certain incorporated content items and use the information to determine if such a story using non-vetted information should be published.

Vetting module 30 also includes provisions for vetting annotation to advantageously designating materials as validated and which have not. Such vetting annotation may be applied to the sources of the content items and when the content item emanates from a human contributor vetting annotation may be applied to information relating to the contributor name, profession, and other relevant credentials or personal information.

All vetting annotation may also include information regarding the identity of the editor performing the vetting, the time and place the vetting was performed and the nature of vetting.

As noted above, the vetting module provides confidence building measures including research tools enabling independent verification of the online-content and its incorporated content items by readers, thereby enhancing their confidence in the credibility of the content and the content management, as will be discussed.

Following are various corroboration factors contributing to site credibility in certain embodiments; accuracy, authority, currency, coverage, and objectivity.

Accuracy refers to the degree to which the site is error free and is well produced. The presence of outside verification, clearly written and well-organized content, sources, and statistics imbue reader confidence in credibility of the materials emanating from such a source site.

Authority refers to the individuals responsible for the site content. Availability of contact information, formal credentials, qualifications, and affiliations, are all relevant issues effecting site credibility. Sample queries for evaluating site authority include:
Does the site have an author?
Is the author qualified?
Is the author an expert?
Is the page signed?
Who is the sponsor?
Is the sponsor of the page reputable?
How reputable?
Is there a link to information about the author or the sponsor?
If the page includes neither a signature nor indicates a sponsor, is there any other way to determine its origin?

Currency refers to whether the information is up to date. Sample queries for establishing site currency include:
Is the page dated? If so, when was the last update?
How current are the links?
Have some expired or moved?

Coverage refers to the comprehensiveness or depth of the information provided on the site.
What topics are covered?
What does this page offer that is not found elsewhere?
What is its intrinsic value?
How in-depth is the material?

Objectivity refers to the bias of the site.
Is the information provided fact or opinion?
Does the information show a minimum of bias?
Is the page designed to sway opinion?
Is there any advertising on the page?

Vetting module 30 is also configured to issue reports summarizing vetting findings in the form of credibility metrics, as will be further discussed.

Feedback module 31 is a module configured to receive reader feedback and generate confidence level metrics for publication for other readers.

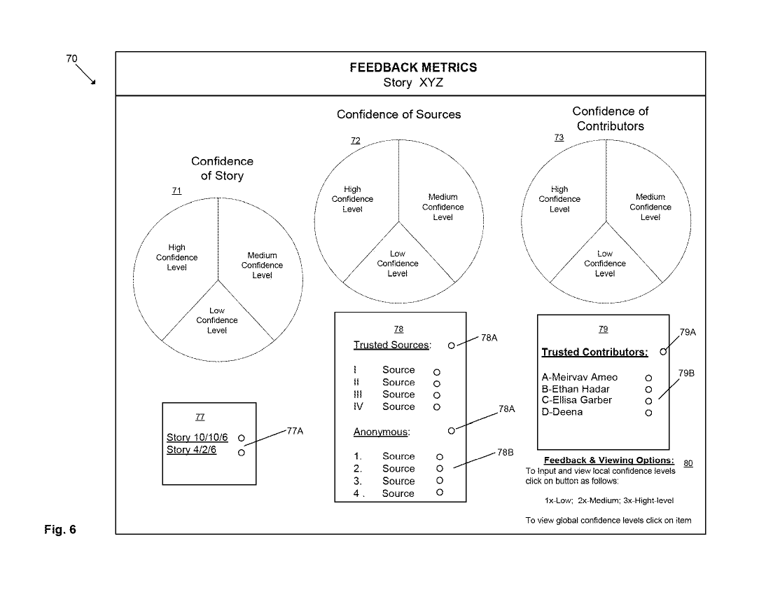

Specifically, readers are provided with an option of providing feedback into the system in which they may express a level of satisfaction or confidence in the online-content, the sources, and contributors from which the content items incorporated in the online-content emanated. It should be appreciated that various forms of input are included in the scope of this invention. For the purposes of this document, a sample feedback configuration in which readers supply three levels of confidence will be discussed in the context of FIG. 6.

It should be further appreciated that any combination of features set forth are also included within the scope of the present invention.

Data management block 20 includes original content 21, editing record 22, collected data 23, computed data 24, contributor data 25, reader contributions 26, and navigation data 27, and in a certain embodiment runs over a big-date storage.

Original content item 21 is a data storage resource designated for raw content from uploads or contributions and includes items like, inter alia, video content, audio content, non-printed text, images, site links, and printed text, according to an embodiment.

Editing record 22 includes records of investigative or vetting work performed by an editor or reader on content items. For example, editing record 22 may include a clarification of the type of content (e.g. video, image, or text) or a clarification of the geographical location at which it was created or any other information deemed relevant. In regards to the contributor, editing record 22 may also include interactions between the editor and the content contributor, or records relating to personal information of the contributor like profession, age and address.

Collected data 23 refers to various types of metadata collected from the original content items incorporated in a story based on various attributes of the content items. For example, one type of metadata is a count of data items obtained from a particular source type or specific source. Source types include cyber sources, academic papers, or news media, for example; whereas, specific sources include sites like YouTube (www.youtube.com), or Wikipedia (www.wikipedia.com), for example. In a certain embodiment, the metadata relates to particular features of the source of the content items incorporated into the story. For example, a count may be based on the degree in which the source is known; well-known, known but not publicly, or entirely anonymous or on the basis of permissions levels; public, trusted, of proportional, relative terms, depending on the particular implementation.

It should be appreciated that various data attributes may be used for metadata purposes and may also be included in the collected data unit 23, according to an embodiment.

Computed data 24 is closely related to collected data 23 and is typically useful in establishing credibility of content items, in certain embodiments. Examples of such computations include, inter alia, the proportion of published items emanating from a particular type of source, the proportion of published items in a story emanating from an identified contributor, the number of stories incorporating a particular content item, or proportion of vetted items incorporated in a particular story. Additional counts may be based on their contributor or a fraction of published content items attributed a contributor, either locally or globally.

Contributor data 25 includes personal and professional information relating to the contributor, according to an embodiment. Such information includes, inter alia, name, age, address, academic credentials, and attended institutions of education.

Reader contributions 26 include feedback information contributed by reading community or public. These reader contributions include feedback relating to the level of credibility of the story, the incorporated content items, and their respective contributors, according to an embodiment.

Navigation data 27 is a type of federated data base maintaining remote reference to external sources and acts as remote access for the actual source, according to an embodiment. For example, pointer data actuated by hyperlinks may enable user navigation between content items appearing on a story page, credibility metric, contributor page feedback metric or contributor page and enables the reader to navigate between multiple links as needed to perform an in-depth analysis of content items contributed and contributor credentials.

In operation, creation of a story is accomplished when contributors A, B, C, D, etc. contribute content items or small data items. For example, contributor “A” provides items A1-A12, contributor “B” provides items B1-B6, contributor “C” provides items C1-C6, and contributor “D” provides items D1-D12.

Editor “XX” combines items A1-A3, A6, B2, B7-B8, C2, C5, and D1, into story “AA”. Similarly editor “YY” combines items A5-A6, B3, and D1 into story “BB” and the stories are displayed on story pages of a content management system.

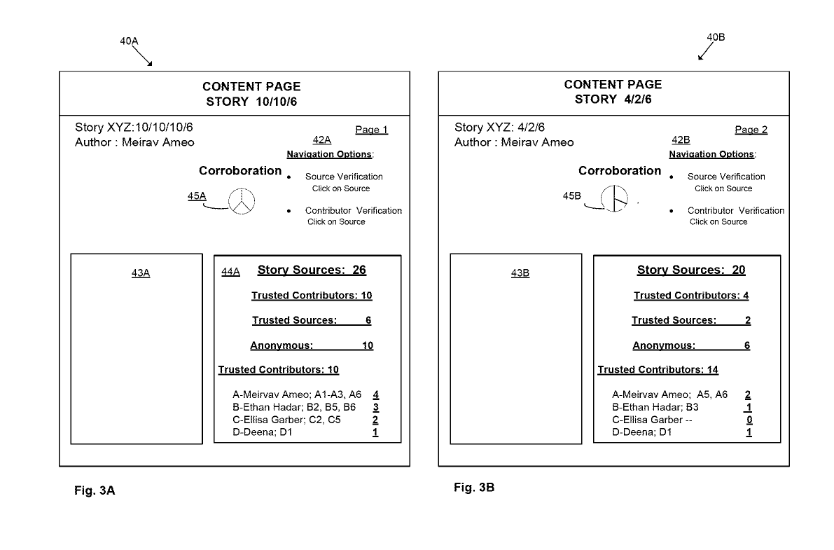

FIG. 3A is a first page of a sample story or content page 40A including story 43A, numerical and graphical representation 44A and 45A, respectively, of corroboration levels of sources whose material is incorporated into story 43A. In certain embodiments, the story title is encoded in a manner conveying these corroboration levels. For example, a story “AA” may be encoded as “XYZ” to indicate “X” number of corroborated contributors willing to publicized, “Y” number of corroborated non-human sources and “Z” number of uncorroborated sources, according to an embodiment.

Furthermore, page 40A includes navigation instructions 42A to facilitate independent reader browsing among story sources 44A, embedded as hyperlinks, of previously corroborated, trusted contributors and sources.

Continuing with the above example, story 43A includes content items A1-A3, A6, B2, B7-B8, C2, C5, and D1. Contributor “A” is noted in the system as Meirav Ameo, having contributed four items incorporated into story 43A, contributor “B”, Ethan Hadar, contributed incorporated three items, contributor “C”, Ellisa Garber, contributed two incorporated items, and contributor “D”, Deena, contributed one incorporated items.

FIG. 3B is a second story page 40B of story “BB”, encoded as 4/2/6 in accordance with above-described, naming convention. Page 2, 40B also includes the above-noted features; the story itself, 43B, textual and graphical representations of the corroboration levels 44B and 45B, respectively, and navigation options, according to an embodiment. However, as shown the relative corroboration levels are different as well as the proportion of contributor input.

Story 43B incorporates items content from content from trusted contributors A5-A6, B3, and D1 such that only four items of the twenty items incorporated emanate from trusted contributors, for example. In regards, to the relative contribution of the contributors, as shown contributor “A”, Meirav Ameo, contributed two incorporated items, contributors “B”, Ethan Hadar, “D”, Deena, contributed only one incorporated item, whereas contributor “C” did not contribute any item to story 43B. The relative incorporated contribution of each contributor is tracked on a both an individual and global basis, as will be further discussed.

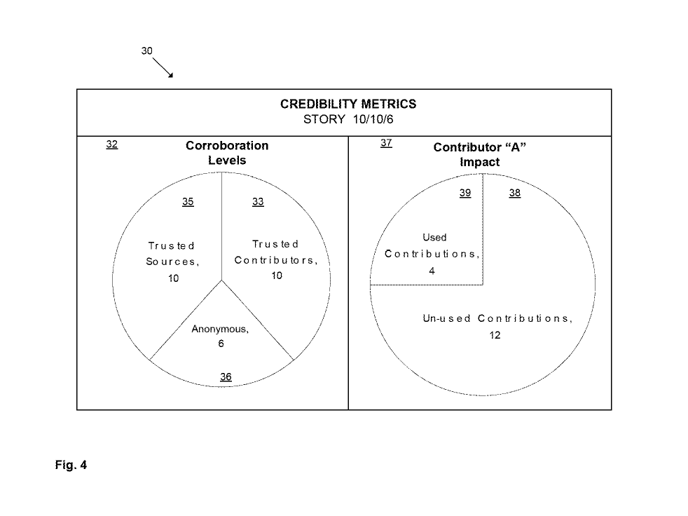

FIG. 4 depicts a dashboard 30 containing two sample graphical representations of credibility meters implemented as pie charts of the story page of FIG. 3A; “Corroboration Levels” 32 and “Contributor Impact” 37.

As shown, chart 32 depicts the proportion of incorporated items emanating from trusted contributors 33, anonymous sources 35, and trusted sources 36. As noted above, the total content emanating from trusted contributors totals ten items; A1-A3, A6, B2, B7-B8, C2, C5, and D1 whereas content emanating from trusted, non-human sources totals six, and ten items emanating from anonymous sources as depicted in pie sections 33, 36 and 35, respectively.

Similarly, the graphical representation of “Contributor Impact” 37 depicts the fraction of the total number of contributions from received contributor “A” were actually incorporated into story “AA”, i.e. story 10/10/06. In the above example, contributor “A” submitted twelve items, A1-A12, of which four of them, A1-A3 and A6, were incorporated; or 25% of the material was actually incorporated in story 43A while the remaining 75% were not as shown in sections 39 and 38, respectively. It should be appreciated that in certain embodiments, contributor impact is depicted in terms of global or subject based impact.

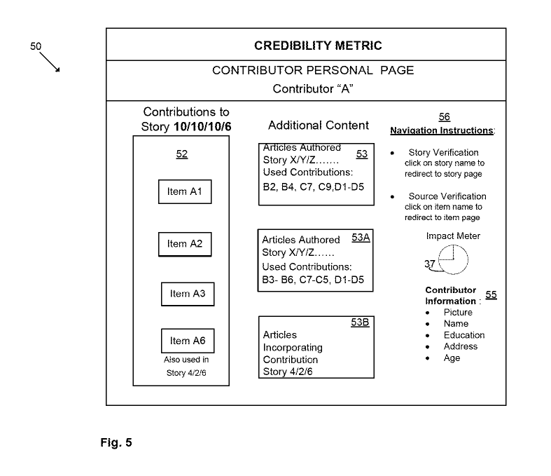

FIG. 5 is a credibility meter depicting a sample contributor page 50 in which the effectiveness of material emanating from contributor “A” is summarized in terms of its incorporation into various articles.

Specifically, incorporated contributions “Items A1-A6” in story 10/10/06 are listed in window 52. Stories authored by contributor “A” and also contributions incorporated in other content are depicted in windows 53-53B. These windows also list contributions from other contributors included in other stories thereby providing a view of the relative impact of contributor “A” in each story. Contributor page 50 also includes graphical depiction of the contributor's impact in regards to a particular story 37, and navigation instructions 56 to facilitate verification, according to an embodiment.

As shown, contributor “A” has contributed items “A1-A6” for story 10/10/6 and “Item A6” is also incorporated into story 4/4/6.

Articles authored by contributor “A” appear on the contributor page 50 and also incorporated content emanating from other users; content items B2, B4, C7, C9,D1-D5 are incorporated in story 53 and items B3-B6, C7-05, D1-D5 D5 are incorporated in story 53A. Contributor information 56 includes a picture of the contributor, education, address, age, or other relevant information as selected by users.

FIG. 6 is a sample feedback page 70 graphically depicting dedicated confidence metrics for published stories 71, a source of content items 72, or contributors 73, according to an embodiment.

As shown, each of metrics 71-73 is implemented as a pie chart depicting three possible levels of confidence levels; low, medium, and high, according to an embodiment. It should be appreciated, that various display formats and expressions of confidence or reader satisfaction are also included within the scope of the present invention.

In certain embodiments, feedback page 70 includes feedback windows 77-79, for the story, sources of incorporated content items, and incorporated content items created by contributors, respectively.

As shown, each window is equipped with feedback buttons; one for each item. For example, a user can supply feedback for either of stories 10/10/6 or 4/2/6 by pressing on buttons 77A; each button in line with the item for which the feedback is being supplied. Source input window 78 is equipped with virtual feedback buttons 78A for general trusted or anonymous source feedback and buttons 78B for feedback relating to individual trusted or anonymous sources. Similarly, contributor input window 79 is also fitted with feedback buttons, 78A and 78B, configured to supply feedback relating to the overall confidence levels of all contributors and also the confidence level of each individual contributor, according to embodiments.

Feedback and viewing options 80 are also provided and may vary from one embodiment to the next. It should be noted that buttons may be selected by placing a mouse arrow on the virtual button and clicking or placing a finger on the virtual button when using a touch screen.

As shown, each the confidence level fed into the system by a user corresponds to the number of serial button presses; one time represents a low confidence level, two times represents a medium confidence level, and three times represents a high confidence level. It should be appreciated that various input configurations enabling a reader to convey a confidence level of a particular item is included within the scope of the present invention.

In certain embodiments, the management system calculates confidence level of each item in view of all of the feedback on file for that the particular item. The particular confidence metric appearing on page 70 relates to the item for which feedback is currently supplied. For example, as shown there are two possible metrics that can appear for the story, ten for the sources, and five for the contributors. A reader pressing button 78A in rapid succession conveys to the system a medium level of confidence for the collective group of trusted sources whereas as upon pressing button 78B the reader conveys to the system a low level of confidence of the particular source corresponding to that button, for example.

Following are various examples how users are able to use the above described functionality.

Editors building articles are able to access text, pictures, video from external online sources and reference them in the article as an item effecting the article and document the chain of reasoning emanating from the reference. This information can be used later for others to validate the level of corroboration affecting the story. These changes are exhibited in article metrics.

Readers and editors are able to view itemized lists of contributors and content items they provided, references from external sites incorporated in the article. During editing, editors are able to navigate into the content item incorporated into the story for further analysis and re-reading.

Chief editors are able to generate pre-publishing, vetting reports reporting the proportion of supporting references previously vetted by editorial staff or others. Furthermore, they are able to navigate between content items and their sources to ascertain reasons for the absence of vetting activities for some items and the presence of vetting activities for other items. This information may be used to determine if an article should be published or not.

Chief editors are able to track a “paper trail” of evidence supporting a story created by their staff, ensuring proper vetting, thereby facilitating proper governance is applied to published content.

Readers are able to identify information and responsible individuals, agencies or technology used to create the article and view the relative contribution in a form comfortably and reliably conveying relative impact of each contributor and source. Particularly, readers are able to view the number of content items incorporated per contributor for each story currently being read. Furthermore, readers are able to navigate into the personal page of each specific contributor to view all content items lists used for creating the story.

Readers are able to examine both known and unknown, cyber information-sources and be directed to the source page to view the items used.

A reader can view a list of items a contributor provided to a story by viewing the personal page of a contributor. The reader can interrupt browsing contributions list at any point to navigate to chosen items and view data and information of interest.

A reader, can identity other stories to which a particular contributor contributed information items and ascertain the number of items contributed to those stories and also and indentify items that were incorporated into stories and those that were not.

Product owners may leverage the content management system to encourage participation of the community, by enabling visibility and scrutiny of the published content, driving engagement that leads to contribution, purification of information, and overall gamification based on interest, prestige, and credits.

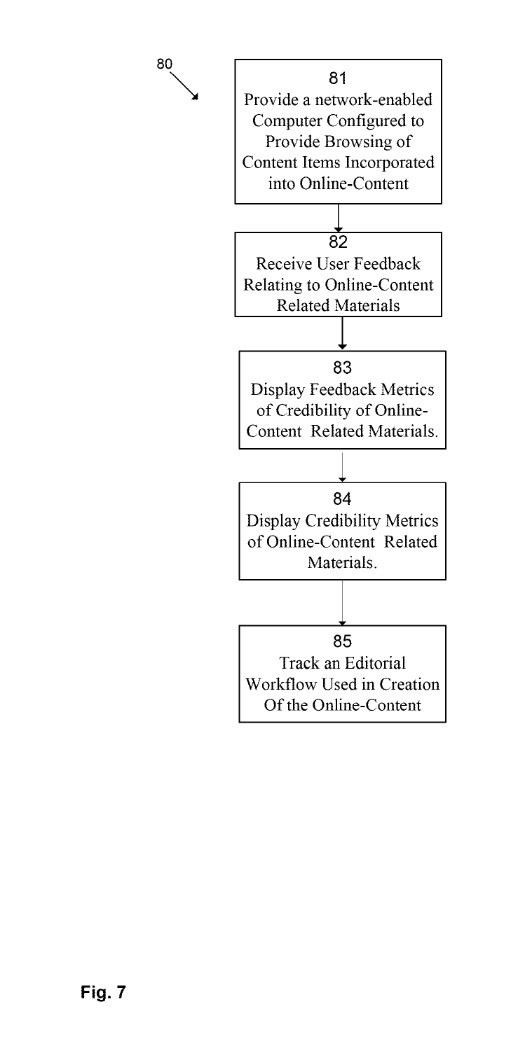

FIG. 7 depicts a flowchart 80 of an embodiment of the present invention in which step 81 a network-enabled computer of a content management system is provided. The network-enabled computer is configured to provide browsing capabilities of content items incorporated into online-content. In step 82, the network-enabled computer receives user feedback data relating to the online-content. In step 83, the network-enabled computer displays feedback metrics generated from the feedback data. In step 84, the network-enabled computer displays credibility metrics relating to published online-content. In step 85, the network-enabled computer tracks editorial workflow used in the creation of the online content.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A content management system for corroborating on-line content derived from crowd sourcing, the system comprising:
a network-enabled computer configured to:
display online-content moderated from one or more content items provided by a plurality of contributors, the content items displayed as hyperlinks, the hyperlinks linked to respective sources of the content items so as to enable reader browsing of the sources;
receive reader feedback relating to the sources; and
display at least one feedback metric derived from the reader feedback.

2. The content management system of claim 1, wherein the content items are selected from the group consisting of video content, audio content, non-printed text, image, site link, and printed text.

3. The content management system of claim 1, wherein the sources are selected from a group consisting of people, cyber sources, and literary sources.

4. The content management system of claim 1, wherein the feedback metric includes feedback relating to the online-content or the contributors.

5. The content management system of claim 4, wherein the feedback metric defines at least one confidence level of the credibility of the online-content or at least one of the plurality of contributors.

6. The content management system of claim 1, wherein the feedback metric is implemented as a graphical depiction of user confidence of the story or the contributors.

7. The content management system of claim 1, wherein the computer is further configured to display at least one credibility metric relating to either the online-content, at least one of the content items, or at least one of plurality of contributors.

8. The content management system of claim 7, wherein the credibility metric includes a graphically depiction of a proportion of the content items emanating from sources that are verified.

9. The content management system of claim 8, wherein the credibility metric includes a graphically depiction of one or more levels of verification of the sources incorporated into the online-content.

10. The content management system of claim 7, wherein the credibility metric includes a graphically depiction of a proportion of content items incorporated into online-content contributed by a contributor.

11. The content management system of claim 1, wherein the computer is further configured to track editorial workflow in creation of the content.

12. A method for establishing credibility in crowd sourced content, the method comprising:
providing a network-enabled computer configured to:
display online-content moderated from one or more content items provided by a plurality of contributors, the content items displayed as hyperlinks, the hyperlinks linked to respective sources of the content items so as to enable reader browsing of the sources;
receive reader feedback relating to one or more of the sources; and
display at least one feedback metric derived from the reader feedback.

13. The method of claim 12, wherein the content item is selected from the group consisting of video content, audio content, non-printed text, image, site link, and printed text.

14. The method of claim 12, wherein the sources are selected from a group consisting of people, cyber sources, and literary sources.

15. The method of claim 12, wherein the feedback metric includes feedback relating to the online-content or the contributors.

16. The method of claim 12, wherein the feedback metric defines at least one confidence level of the credibility of the online-content or at least one of the plurality of contributors.

17. The method of claim 12, wherein the feedback metric is implemented as a graphical depiction of user confidence of the story or the contributors.

18. The method of claim 12, wherein the computer is further configured to display at least one credibility metric relating to either the online-content, at least one of the content items, or at least one of the plurality of contributors.

19. The method of claim 18, wherein the credibility metric includes a graphically depiction of a proportion of the content items emanating from sources that are verified.

20. The content management system of claim 19, wherein the credibility metric includes a graphically depiction of one or more levels of verification of the sources incorporated into the online-content.

21. The content management system of claim 18, wherein the credibility metric includes a graphically depiction of a proportion of content items incorporated into online-content contributed by a contributor.

22. The method of claim 12, wherein the computer is further configured to track editorial workflow in creation of the content.
